(19) United States
(12) Patent Application Publication
(10) Pub. No.: US 2008/0114734 A1
(43) Pub. Date: May 15, 2008

(54) INFORMATION PROCESSING METHOD AND SYSTEM

(75) Inventor: Takeshi SUWABE, Tokyo (JP)

Correspondence Address: B. TODD;TODD ENGINEERING SALES INC., 28706 HOLIDAY PL., ELKHART, IN, 46517, US

(73) Assignee: CANON KABKUSHIKI KAISHA, Tokyo (JP)

(21) Appl. No.: 11/873,938

(22) Filed: Oct. 17, 2007

(30) Foreign Application Priority Data
Nov. 13, 2006 (JP) 2006-307224

(51) Int. Cl. G06F 17/30

(52) U.S. Cl. 707/3; 707/E17.014

(57) ABSTRACT

The invention provides service search technology that is more user-friendly and that places less of a burden on the network. To accomplish this, services on a network are searched and the search results that are obtained are used to create a service list, which is saved (S701 through S703). The saved service list is read and displayed (S712). A user inputs an operation to indicate a service to be received (S704 through S706). The services that are included in the service list are changed according to this input operation (S709 through S711).

### BACKGROUND OF THE INVENTION

1. Field of the Invention

The present invention relates to methods and systems of searching for services on a network.

2. Description of the Related Art

Conventionally there have existed network systems, in which a plurality of information devices are connected, and that can acquire a desired service from a device on the network through an operation to a client device. The conventional systems issued a search request for a service on the network, presented the search results to the user as a result list, allowed the user to select a desired service from that service list, and then provided the designated service.

For example, the system disclosed in Japanese Patent Laid-Open No. 2001-109693 is one known example of a system that performs such a search. With this technology, when searching for a device such as a digital compound device, a request for a search for the device is made to a search server using the device class (printer, etc.), static data (stable function, etc.) and dynamic data (consumables information, etc.) as search conditions, and the results are displayed.

With this conventional technology, however, the actual search is performed after the various search conditions have been set, and unless the desired search result is obtained, it is necessary to change the search conditions and execute the search again, and each time this results in a period of waiting for the search results and causes the user to waste time waiting. Moreover, because searching was performed a number of times, there was a large burden on the network.

Further, when the search results included hits for numerous services, too much time and effort was required on the part of the user to select the desired service from among the many services.

### SUMMARY OF THE INVENTION

The present invention allows realization of a service search technology that is more user-friendly and that places less of a burden on the network.

According to one aspect of the present invention, the foregoing problem is solved by providing an information processing method comprising searching for services that exists on a network, creating and saving a service list based on the searching result, displaying the service list that has been saved, inputting an operation which is related to one of services included in the displayed service list and changing the service list, in accordance with the input operation.

According to another aspect of the present invention, the foregoing problem is solved by providing an information processing system comprising a search unit configured to search for services on a network, a creation unit configured to create and save a service list using the results obtained by the search unit, a display unit configured to read out and display the service list that has been saved, an input unit configured to allow a user to input an operation which is related to one of services included in the service list displayed by the display unit, and a service list changing unit configured to change the service list, in accordance with the operation input by the input unit.

According to still another aspect of the present invention, the foregoing problem is solved by providing a computer-readable storage medium storing a computer program that causes a computer to execute, the computer program comprising a code to search for services that exists on a network, a code to create and to save a service list based on the searching result, a code to display the service list that has been saved, a code to input an operation which is related to one of services included in the displayed service list and a code to change the service list, in accordance with the input operation.

Further features of the present invention will become apparent from the following description of exemplary embodiments with reference to the attached drawings.

### BRIEF DESCRIPTION OF THE DRAWINGS

FIG. 1 describes an example of a system configuration according to a first embodiment of the invention.

FIG. 2 describes the internal structure of an image processing system according to the first embodiment of the invention.

FIG. 3 describes an example of a system configuration according to the first embodiment of the invention.

FIG. 4 describes an example of a system configuration according to the first embodiment of the invention.

FIG. 5 describes an example of a system configuration according to the first embodiment of the invention.

FIG. 6 describes an example of a service list according to the first embodiment of the invention.

FIG. 7 describes an example of the operation portion (top screen) display according to the first embodiment of the invention.

FIG. 8 describes an example of the operation portion (top screen+service list display) according to the first embodiment of the invention.

FIG. 9 describes an example of the operation portion (copy screen+service list display) according to the first embodiment of the invention.

FIG. 10 describes an example of the operation portion (copy screen+service list display) according to the first embodiment of the invention.

FIG. 11 describes an example of the operation portion (copy screen+service list display) according to the first embodiment of the invention.

FIG. 12 describes an example of a service list according to the first embodiment of the invention.

FIG. 13 describes an example of the operation portion (copy screen+service list display) according to the first embodiment of the invention.

FIG. 14 describes an example of the operation portion (copy screen+service list display) according to the first embodiment of the invention.

FIG. 15 describes an example of a service list according to the first embodiment of the invention.

FIG. 16 is a flowchart that describes the flow of processing by the information processing system according to the first embodiment of the invention.

FIG. 17 is a flowchart that describes the flow of processing by the information processing system according to a second embodiment of the invention.

FIG. 18 is a flowchart that describes the flow of processing by the information processing system according to a third embodiment of the invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

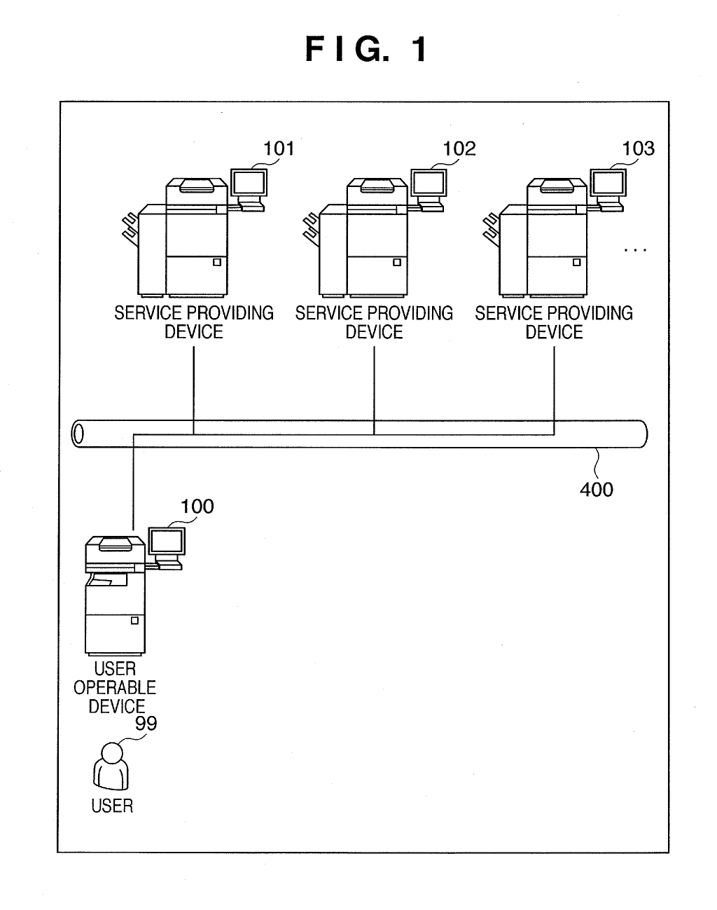

FIG. 1 shows the configuration of a network system according to a first embodiment of the invention. The network is constituted as an information processing system by connecting a user operable device 100, and service providing devices 101, 102, and 103, to a LAN 400. The service providing devices 101, 102, and 103 supply their various functions to the outside as services. The user operable device 100 uses the services that are provided by the service providing devices 101, 102, and 103 via the network in response to a command by a user 99 (or based on a determination by the user operable device 100 itself).

Further, in order for the service providing devices 101, 102, and 103 to provide services, they can present information that indicates the services that they hold to the outside in advance. The user operable device 100 sends a packet that indicates a search request to the LAN 400, and by doing so finds information that corresponds to the search request from the information that is presented by the service providing devices, and displays the results to the user 99. The user 99 chooses a service to use from among these, and actually uses that service. In other words, the service providing devices 101, 102, and 103 disclose their functions as services, and when the user operable device 100 desires to use a service, the service can be searched for in the user operable device 100.

The Web service technology of UDDI (Universal Description, Discovery and Integration) is widely and generally known as a technology for service management. UDDI is a so-called “service repository.” The service provider registers information on services to be disclosed, such as the service name and service type, the interface definition, and the access point, with the UDDI. A service user then sends an inquiry to the UDDI regarding what services are available, and can obtain information on those services. This UDDI technology is used in the searching of services in this embodiment, but of course it is also possible to adopt other methods as well.

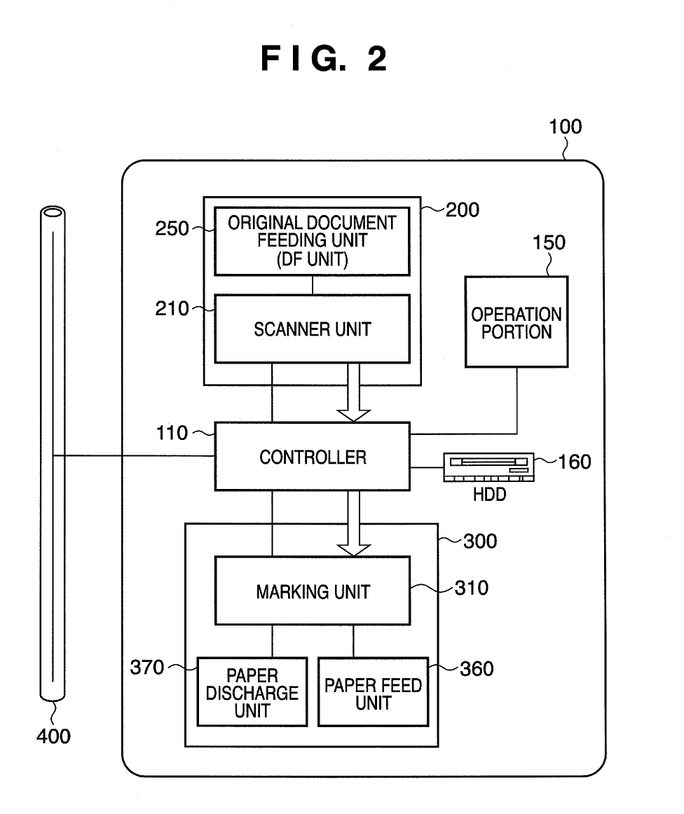

Next, an example of the configuration of the service providing device is described with reference to FIG. 2. A reader portion 200 optically reads an original document image and converts this to image data. The reader portion 200 is provided with a scanner unit 210 that has a function for reading an original document, and an original document feeding unit 250 that has a function for carrying the original document paper one sheet at a time. The original document feeding unit 250 has a guide for recognizing the width of the original document paper that has been set and a switch for detecting the length of the original document paper, and has the function of recognizing the size of the original document paper. Depending on the configuration of the device, it is also possible for it not to include the original document feeding unit 250 (in this case, the device recognizes the original document size with a sensor such as a photo interrupter when the original document is placed on the platen glass (original document rest)). A printer portion 300 feeds recording paper, and forms the image data on the recording paper as a visible image and then discharges the paper outside of the device. The printer portion 300 includes a paper feed unit 360 that has a plurality of types of recording paper cassettes, a marking unit 310 that transfers and fixes the image data onto the recording paper, and a paper discharge unit 370 that sorts and staples the printed recording paper and sends it outside the device. A controller 110 is electrically connected to the reader portion 200 and the printer portion 300, and is also connected to the LAN 400. The controller 110 has a CPU and a working memory, for example, and controls the overall operation of the user operable device by loading program code stored on a HDD 160 to the working memory and then interpreting the program code with the CPU. The controller 110 also provides a copy function that is achieved by controlling the reader portion 200 to output the image data obtained by reading the image on the original document to the printer portion 300, and then forms the image on the recording paper. It also provides a network scanner function of converting the image data obtained by the reader portion 200 reading the image on the original document to code data and then sending the code data to the host computer via the LAN 400. It also provides a printer function in which the code data that are received from the host computer through the LAN 400 are converted to image data and output to the printer portion 300. An operation portion 150 has a liquid crystal display portion, a touch panel input device that is attached onto the liquid crystal display portion, and a plurality of hard keys, and provides a user I/F for the user to perform various operations. A signal that has been input through the touch panel or the hard keys is transferred to the controller 110, and the liquid crystal display portion displays the image data that has been sent from the controller 110. In addition to storing the program code that is executed by the controller 110, the HDD 160 also stores the image data from the reader portion 200, image data that have been received over the LAN 400, and various setting data, for example.

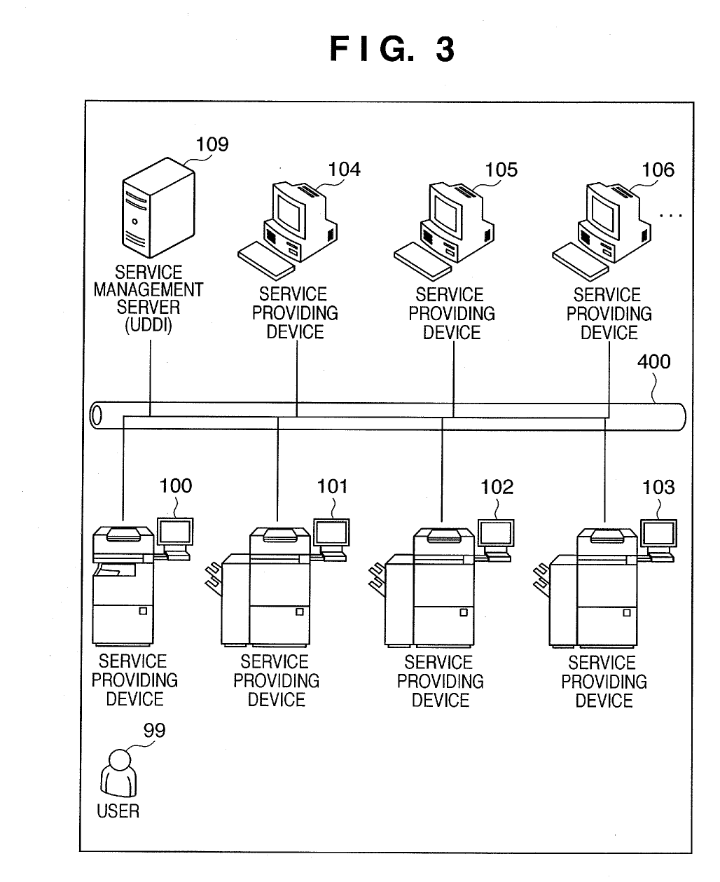

FIG. 3 shows an example of the configuration in a case where a UDDI is used. Service information from service providing devices 104, 105, and 106, and 101, 102, and 103 is registered to a service management server (UDDI) 109, and a search is performed on the service management server (UDDI) 109 from the user operable device 100. In some cases there may be a plurality of service management servers (UDDI) 109.

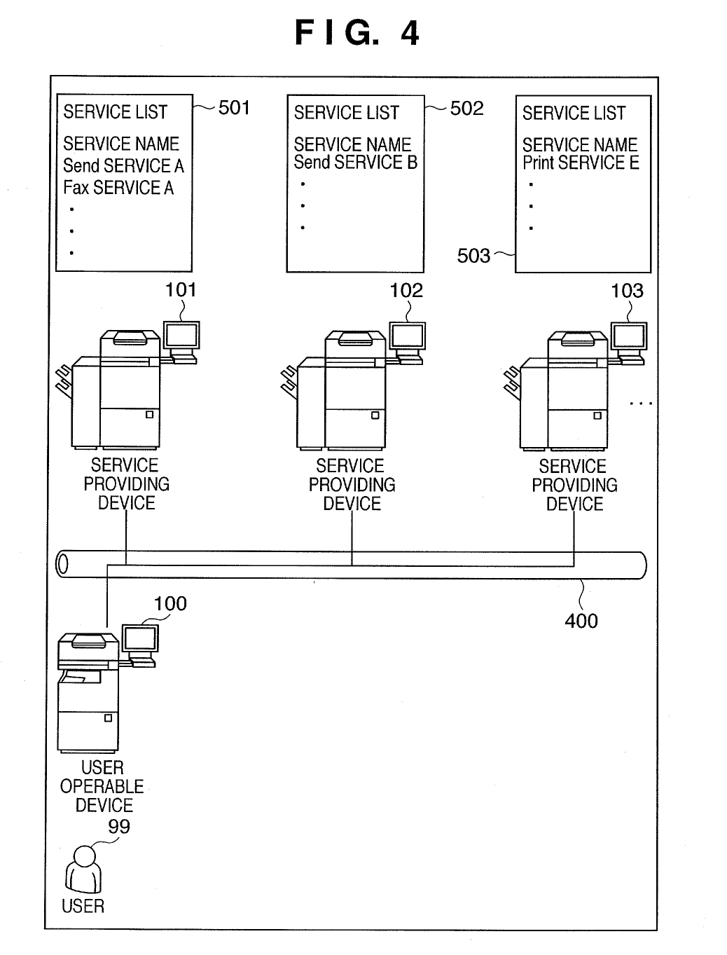

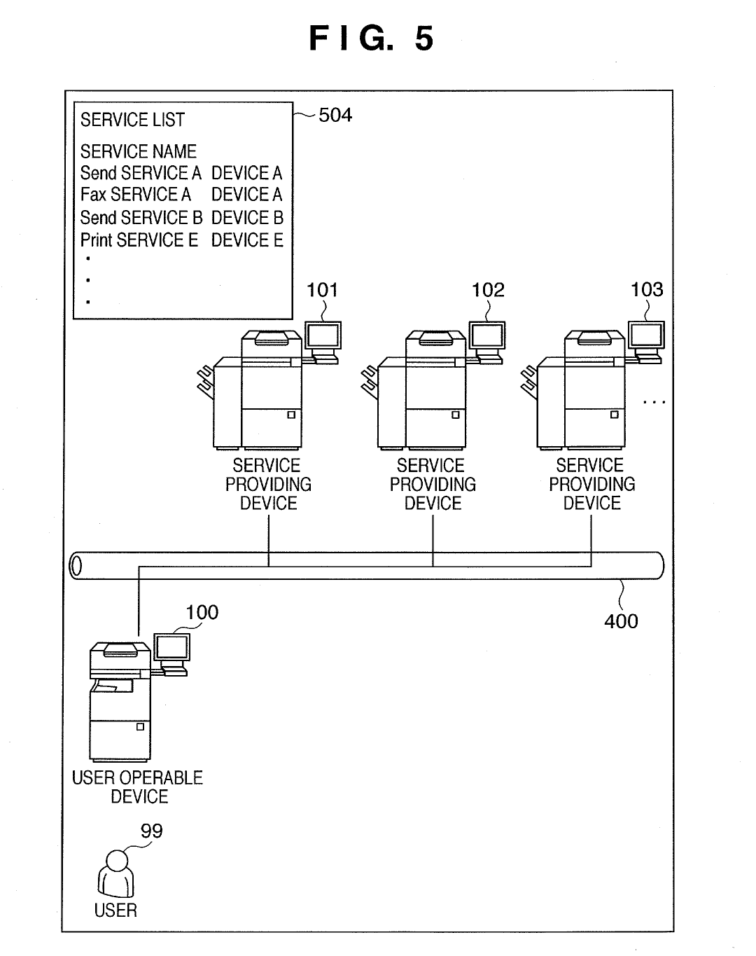

Next, using FIGS. 4 and 5, the location of the service management server that corresponds to the UDDI is described. FIG. 4 is an example of a case in which a service management server that corresponds to the UDDI described above is held by the service providing devices. Each service providing device 101, 102, and 103 turns its functions into services (makes them useable from other devices) and registers them as a service list. Thus, for example, as shown in service lists 501, 502, and 503, the registered services are listed and stored. In this case, a search for a service is performed on the service providing devices from the user operable device 100.

On the other hand, FIG. 5 is an example of a case in which the service management server that corresponds to the UDDI is realized by only the service providing device 101. Each service providing device 101, 102, and 103 turns its functions into services (makes them useable from other devices) and registers them to a service list 504 that has been readied in the service providing device 101. In this case, the service list functions as the service management server. Then, a service search is performed from the user operable device 100 on only the service management server that has been furnished in the service providing device 101.

As will be described later, in this embodiment, a service list that can achieve a particular service is displayed in synchronization with the operation of setting a function for using that service in cooperation with a service providing device on the network. In order to perform high-speed synchronization between this operation of setting a function and the display of a service list that can achieve this function, it is preferable to obtain information on the configuration and the capabilities of the service providing devices in advance. To do this, the user operable device 100 performs a service search and obtains information on the configuration and the capabilities of the service providing devices in advance. Examples of information relating to the configuration include information on the presence of a finisher and stapler or hole puncher accompanying the finisher, a double-sided unit, and a FAX board, as well as paper feed cassette information. Information on the capabilities includes information on the printer function such as the presence of a color printer function and a processable PDL type, and information on the protocol for the network transmission function (E-Mail, FTP, SMB, etc.). Other examples include information on the send mode for the FAX function (presence of G3, G4, color communication function, etc.). It should be noted that the configuration and the capabilities raised here are only one example, and there is no limitation to only these. It is also possible for the structure or the capability, for example, of the service providing devices to be obtained when the function setting operation is executed.

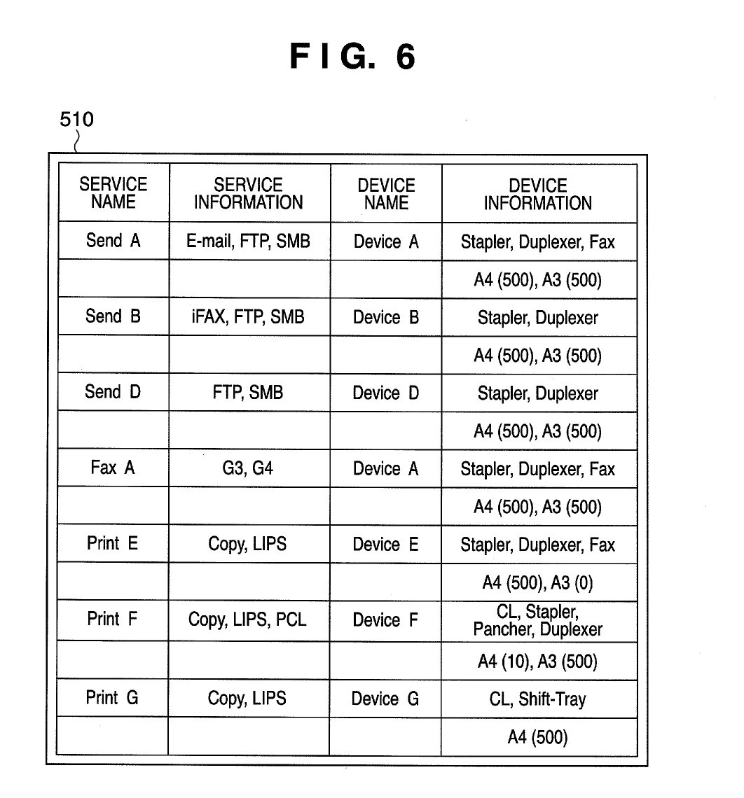

The user operable device 100 obtains service information and device information, for example, from the service management server and creates a service list 510 such as that shown in FIG. 6. The service list 510 is stored on the hard disk 160 or a memory in the controller 110. The service list 510 stores a list of the service information of the service providing devices that has been obtained from the service management server. For example, “Send A” is registered as the service name, and “E-Mail, FTP, SMB” is registered as the service information (here, the useable protocol), for example. Examples of device information include information obtained from individual devices, the device name, information on the presence of functions such as a stapler, a double-sided unit, and a FAX board, for example, and paper feed cassette information such as 500 sheets for an A4 cassette and 500 sheets for an A3 cassette.

To create this service list, the user operable device 100 stores the service information and the device information at a time, for example, when powering up. As for the search conditions at this time, it is possible to obtain all of the services that can be used by the user operable device 100, or alternatively, it is also possible to designate the search conditions in advance and then obtain services by executing a search in accordance with those search conditions. The timing for searching can be freely designated, such as once daily or every N hours (where N=1 or more). In this way, the service information and the device information are obtained and stored before the user performs an operation on the operation portion 150 in order to use a service. By doing this, it is possible to perform, at high speed, processing such as changing the display of the usable service list in synchronization with the function setting operation for using a service. In other words, it is not necessary to perform a search for useable services each time the function settings regarding service use are changed, and it is sufficient to execute the service list according to the service information and device information that has been stored, and thus the service list can be changed at high speed.

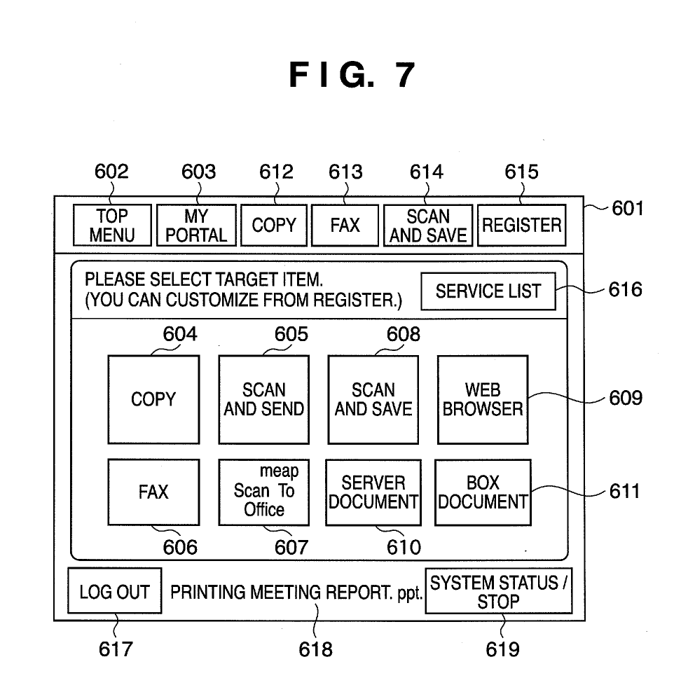

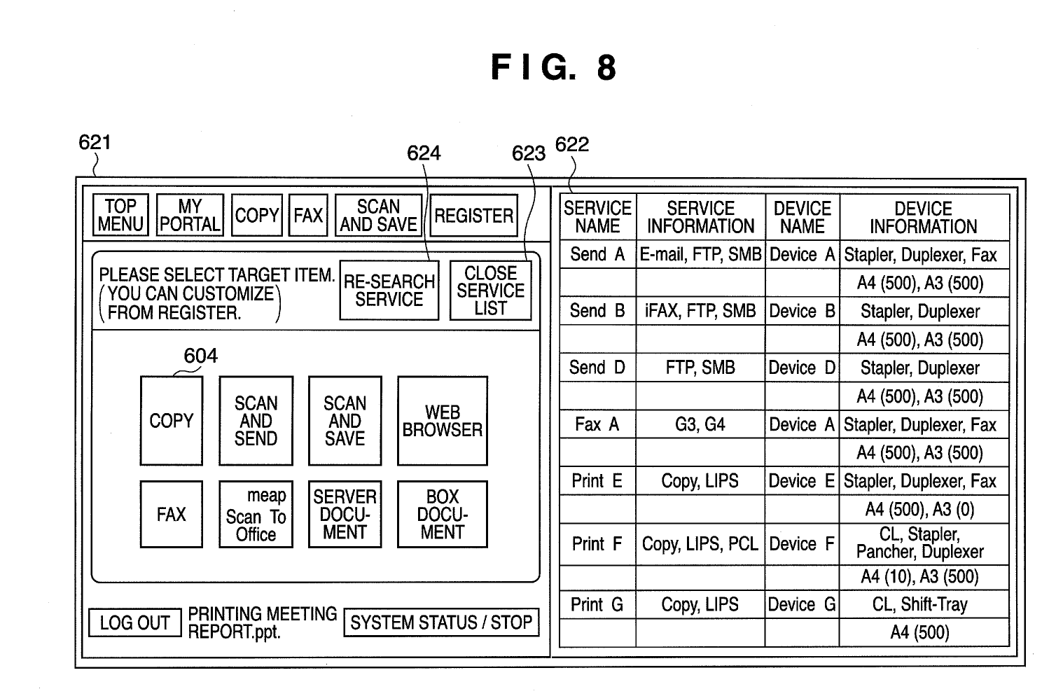

Next, the screen when executing the use of a service with the operation portion 150 is described using FIG. 7. Reference numeral 601 represents the liquid crystal display portion. Reference numerals 602, 603, and 612 through 615 are keys that are always shown, even when the screen below them is switched. Reference numeral 602 is a top menu key that has been provided in order to return to the top menu screen display, such as that shown in FIG. 7, after switching to another screen. Reference numeral 603 is a my portal key which, when pressed, the information relating to the logged-on user (information on jobs entered by the user or a user-unique key display) is extracted and the listed screen is displayed. Reference numerals 604 through 611 are various function keys, and 612 through 614 are shortcut keys for various functions. Reference numeral 615 is the registration key, and is a key for registering shortcut keys that are displayed in 612 through 614. Reference numeral 616 is a service list key for displaying a screen on which a service list of the services can be viewed, such as that shown in FIG. 8. Reference numeral 617 is a log out key for logging out from the current user session. Reference numeral 618 is the status line, and for example is the area for displaying status information on the job being executed or for displaying the consumable (toner, etc.) warning information. Reference numeral 619 is a system status key for displaying a screen on which the executed job list or job log list information can be viewed.

FIG. 8 is a diagram showing the screen that is displayed when the service list key 616 has been pressed on the screen of FIG. 7. As shown in FIG. 8, a service list 622 can be viewed on a liquid crystal display portion 621. The service list 622 is registered in the memory of the user operable device 100 as shown in FIG. 6, and is read out and displayed when the service list key 616 is pressed. Here, since the nature of the service to be used has not yet been specified, the service list shows all of the services that are useable by the user operable device 100, or all of the services that the currently logged in user can use from the user operable device 100. The 623 key is displayed on the service list display, and when the 623 key is pressed, the service list 622 closes and the display returns to that of FIG. 7. Here, a service and device search is performed when powering up, but it is also possible to allow the user to re-perform that search at a desired time using a service re-search key 624. With regard to the re-searching, it is possible for the service list to be updated periodically other than when powering up.

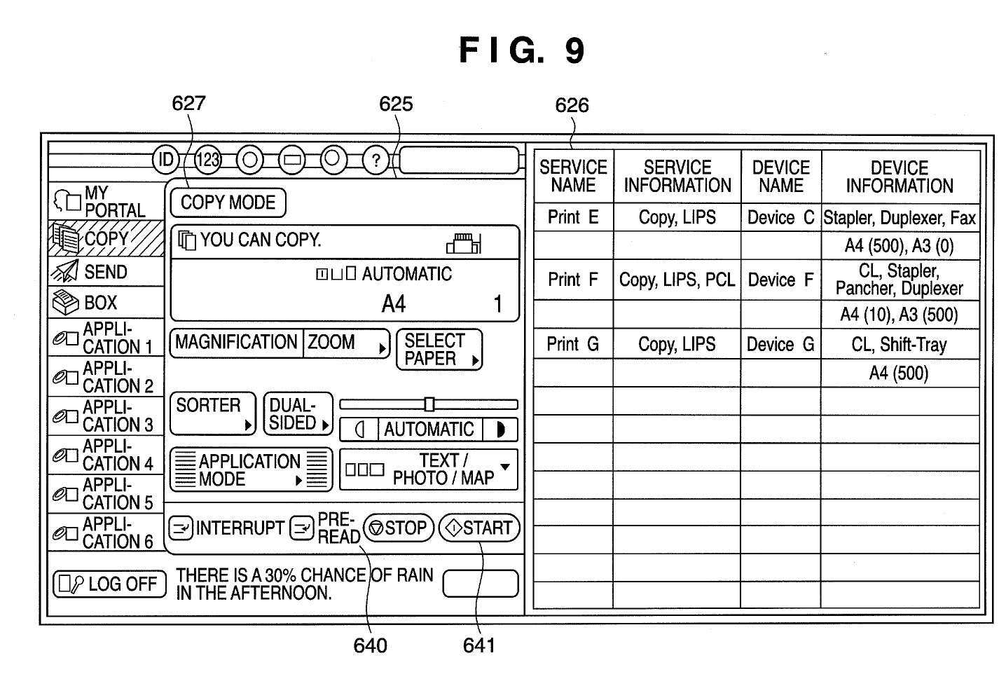

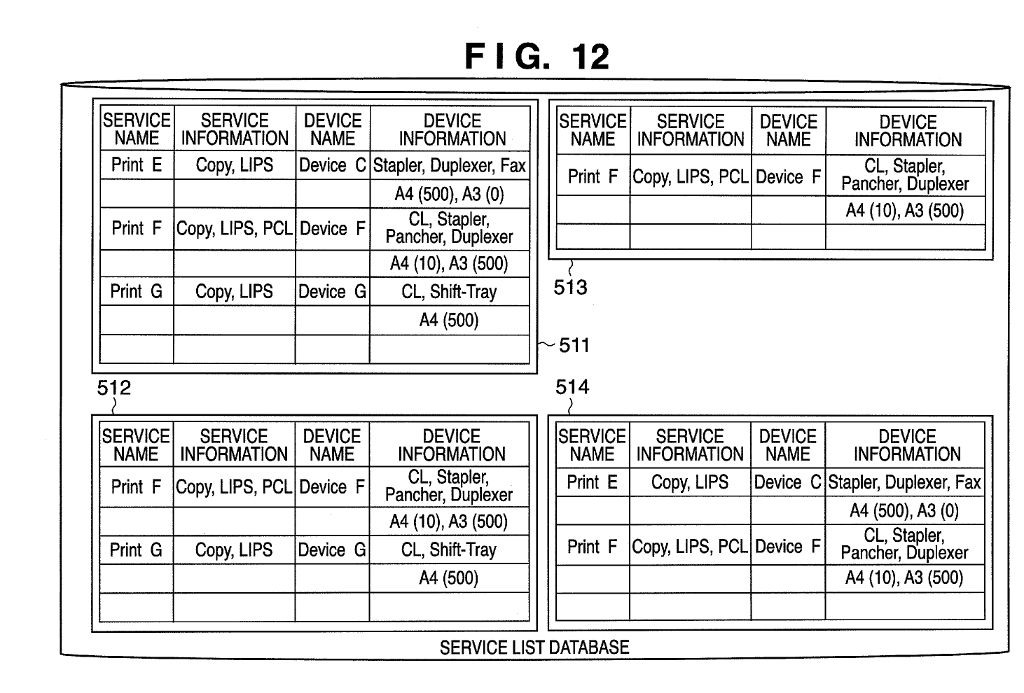

Next, FIGS. 8, 9, 10, and 11 are used to describe a change to the service list in synchronization with the setting of functions for service use. In FIG. 8, when the user presses the copy key 604 at this point, for example, services and devices on the service list 510 of FIG. 6 that do not apply as the copy print destinations are deleted from the service list and are not shown. For example, in the service list 510 of FIG. 6, the services of “Send A,” “Send B,” “Send D,” and “FAX A” are not related to copy printing and thus are removed from the list. In other words, only those services that can work in conjunction with the user operable device 100 as a print destination for the copy, these being “Print E,” “Print F,” and “Print G,” remain on the list. The original service list is saved to the memory in the controller 110 and a new service list is created. The service list 511 of FIG. 12 is an example of this. Then, by reading this service list, the display of the operation portion 150 becomes that of FIG. 9 and a service list is displayed like in 626. 625 is a screen display on which the functions for copying can be set, and 626 is a list display that displays only services that can work in conjunction. It should be noted that when the top menu key 602 is pressed in this state, the saved service list 510 is read out, and the screen returns to a display of the original service list (FIG. 8).

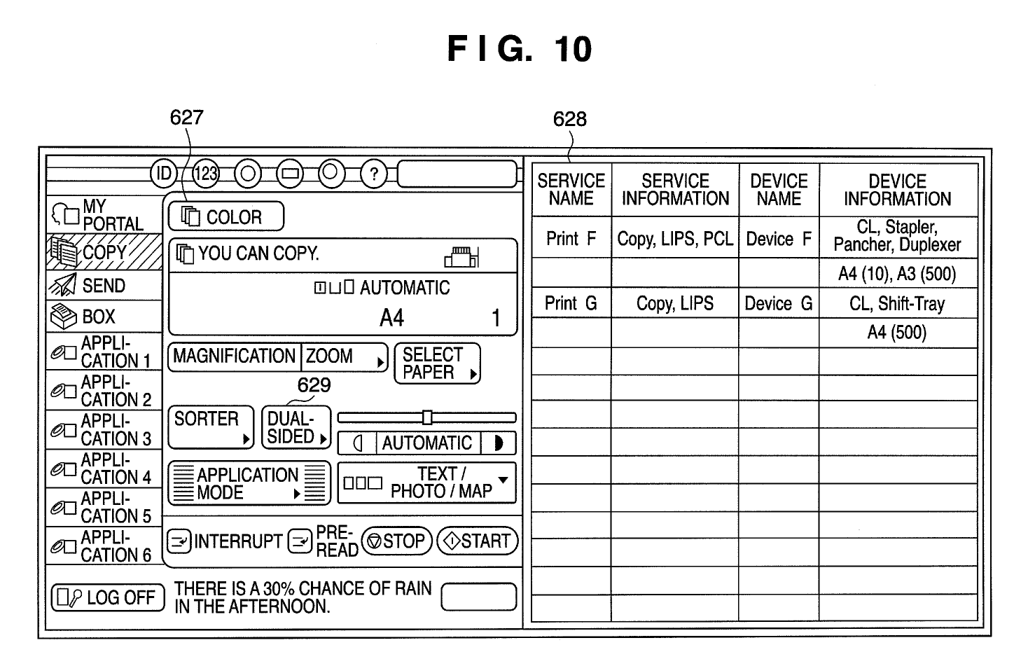

Then, on the screen of FIG. 9, when the copy mode selection key 627 is pressed and color copy is selected, the screen of FIG. 10 is displayed. In other words, when the copy mode selection key of 627 on the screen of FIG. 9 is pressed, the services and devices that do not correspond as print destinations for color copying are deleted from the service list 511 of FIG. 12. For example, on the service list 511 of FIG. 12, the service “Print E” does not include in its device information the notation “CL” that indicates that color copy is possible, and thus is for monochrome-only devices and is removed from the list. That is, only “Print F” and “Print G,” which are services that can work in cooperation with the user operable device 100 as color copy print destinations, remain on the list. The original service list 511 is saved to the memory in the controller 110 and the service list 512 is created as a new list. Then, by reading this list, the service list is displayed like in 628 on the operation portion display as shown in FIG. 10. When the 627 key is pressed in this state and monochrome copy is selected, the service list 511 that has been saved is read out and the screen again returns to the original service list (FIG. 9).

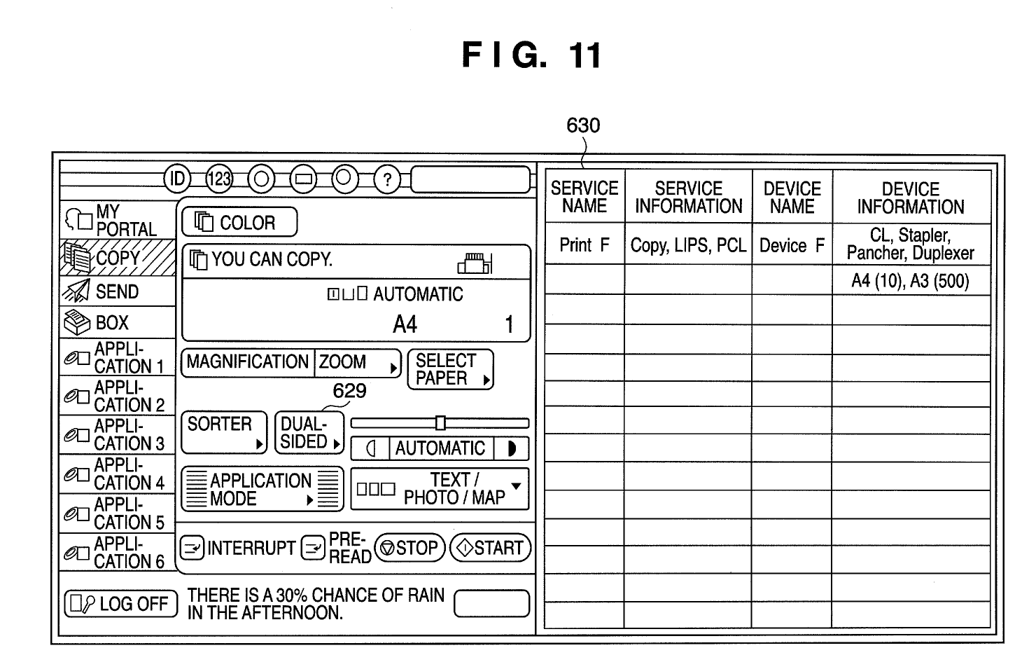

Then, when the double-sided key 629 is pressed on the screen of FIG. 10 to select double-sided printing, the screen of FIG. 11 is displayed. That is, when the double-sided key 629 on the screen of FIG. 10 is pressed, the services and devices on the service list 512 of FIG. 12 that cannot execute double-sided printing are deleted from the service list 512 of FIG. 12. For example, in the service list 512 of FIG. 12, the service “Print G” does not have “Duplexer,” which indicates that there is a double-sided printing function, as device information and does not have a double-sided print function, and thus is removed from the list. That is, color copy is selected as the copy mode and double-sided printing is selected as the printing method, and thus only “Print F,” which is a service that can print color double-sided copies, remains on the list. The original service list 512 is saved to the memory in the controller 110 and a new list 513 is created. The list 513 is read out, and the screen shown in FIG. 12 is displayed on the operation portion. That is, a service list 630 is displayed. If in FIG. 11 there is an order by the user to cancel the setting for double-sided printing, the service list 512 of FIG. 12 that has been saved is again read out, and the display is returned to that of FIG. 10.

The original service lists that were saved on the screens of FIGS. 9 through 11 are stored in the memory of the controller 110 without being deleted. If, for example, on the screen of FIG. 11 the setting for the copy mode is to be cancelled without canceling double-sided printing, the immediately prior setting, the service lists are read out until reaching the service list 511. Then, if the condition for double-sided printing is added after this has been displayed, then a new service list 514 on which services that do not have “Duplexer” have been removed from the service list 511 is created and displayed.

As described in FIGS. 7 through 11, the service information and the device information are searched and saved beforehand, and when the user performs the operation of setting functions in order to use services in cooperation with another device, the service list is changed in synchronization with that operation. By doing this, the user can efficiently and quickly arrive at a desired service. When content that has been set is cancelled, the saved list can be used to quickly return to the original service list.

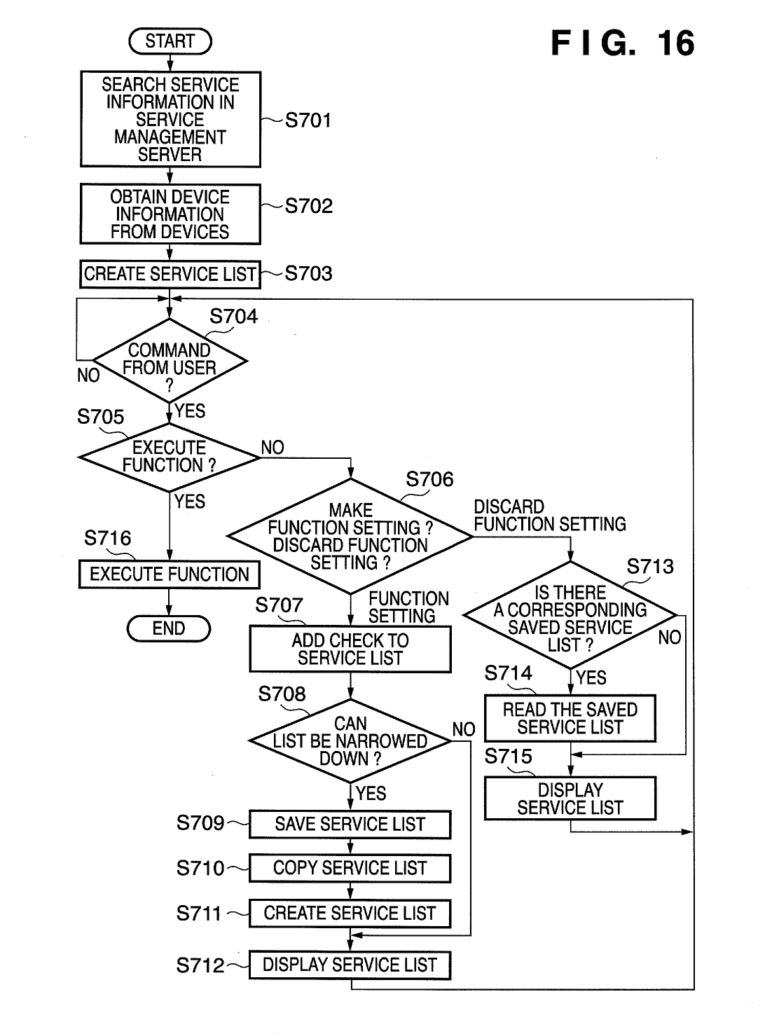

Next, the flow of the processing will be described in specific detail using the flowchart of FIG. 16. FIG. 16 shows the flow of processing executed by the controller 110 in accordance with program code stored on the HDD 160.

First, in S701, when the user operable device 100 is activated, or when a preset search time has been reached, a search request for service information is made to the service management server. Then, the device information of the service providing device is obtained based on this service information in S702. Here, as discussed in the description of FIG. 5, information on the configuration and the capabilities, for example, of the service providing device is obtained.

Then, in S703 a service list 510 such as that described in FIG. 6 is created. As described in FIG. 8, commands from the user are received in S704 in a state where the operation portion 150 is performing the display of a function setting screen for using services and a display of a service list of useable services. When a command is received from a user, the nature of the command is determined in S705 and S706. If it is determined that the command is for setting functions for the use of a service in cooperation with the service providing device, then the procedure advances from step S705 to step S706, and then advances to step S707. For example, as described in FIGS. 8 and 9, when the copy key 604 is pressed, the service list 510 of FIG. 6 is checked in S707. Then, in S708, it is determined whether services and devices that do not correspond as copy print destinations based on the function settings that have been specified can be deleted from the service list, that is, whether or not the service list display can be narrowed down. If yes, then in S709 the original service list 510 is saved to the memory in the controller 110, and in S710 the service list is copied so that it can be read out again when the function settings are later reverted to the original settings. Then, in S711, “Send A,” “Send B,” Send D,” and “Fax A,” which are services that do not correspond as copy print destinations based on the function settings that have been specified, are deleted from the service list. By doing this, a service list in which only “Print E,” “Print F,” and “Print G,” which are services that correspond as print destinations, remain is created, like in the service list 511 of FIG. 12. Next, in S712, the service list is displayed like in 626 of FIG. 9. If in S708 there were no function settings that require a change to the service list, then in S712 the service list is used as it is. After displaying the service list in FIG. 9, the procedure is returned to S704, and service list display changes in accordance with the function settings, such as the color copy setting or the double-sided setting as discussed in FIG. 10 and FIG. 11 are executed by repeating the procedure from S704 to S712.

If in S706 it is determined that the command from the user in S704 is a command to cancel a function that has been set, then in S713 it is determined whether or not a service list was saved in S709. When there is a corresponding service list, in S714 the saved service list is read out and the original list is displayed in S715. When there is no corresponding service list, in S715 the list is displayed as is. The procedure then returns to S704 simultaneous with setting of the functions, and the device enters standby for further commands from the user.

If it is determined in S705 that the content of the command received in S704 is the execution of a function, such as the start of copying, then the procedure is advanced to S716 and the function (copying) is executed in accordance with the designated settings and finished. If the service providing device to be used when executing the function has been specified from the service list, then the image data from the reader portion 200 and the content of the function settings based on the operation are transferred to the specified service providing device by way of the LAN 400. The service providing device that receives this then executes copying by printing the image data in accordance with the specified function settings. It should be noted that if a service providing device has not been specified at this time, then the user operable device 100 executes printing using its own printer portion 300.

Thus, during the operational flow for executing a service in which the user operable device and the service providing device work in cooperation, the user can set a function he would like to use while confirming that this is a service that can be used. Thus, the burden on the user up to selecting and executing a service is reduced, and the problem that too much effort was required on the part of the user to select a desired service from among an enormous number of services is solved. Further, because it is not possible to select a service that cannot work in conjunction, it is also possible to prevent against inadvertently giving the device a job that it cannot process, for example, and thereby solve the problem of not obtaining the result desired by the user. Additionally, because it is not necessary to carry out a search for services at each instance of function setting, there is also an effect against the new problem of increasing network traffic.

### Second Embodiment

An information processing system is described as a second embodiment of the invention. This embodiment uses a case in which the copy function is used as an example, and describes a method of narrowing down the number of services by detecting that the user has set an original document on the reader portion 200. The configuration, etc., of the system is the same as in the first embodiment, and thus identical structures and processes have been assigned the same reference numerals as before and will not be described.

A case in which the copy function is used refers to the state in which the copy key 604 in FIG. 8 has been pressed and the screen of FIG. 9 is displayed. The service list is the service list 511 in FIG. 12, and in FIG. 9, the service list 626 is displayed. Here, a sensor detects the size of the original document that the user has set on the reader portion 200, and for example, determines that the original document is A3 size. Here, as described above, it is possible for this detection to be made using the original document feeding unit 250, or it is also possible for the original document that has been placed on the platen glass to be detected using a photo interrupter. Then, based on the result of this detection, services and devices that are not applicable as a copy print destination for an A3 size original document are removed from the list.

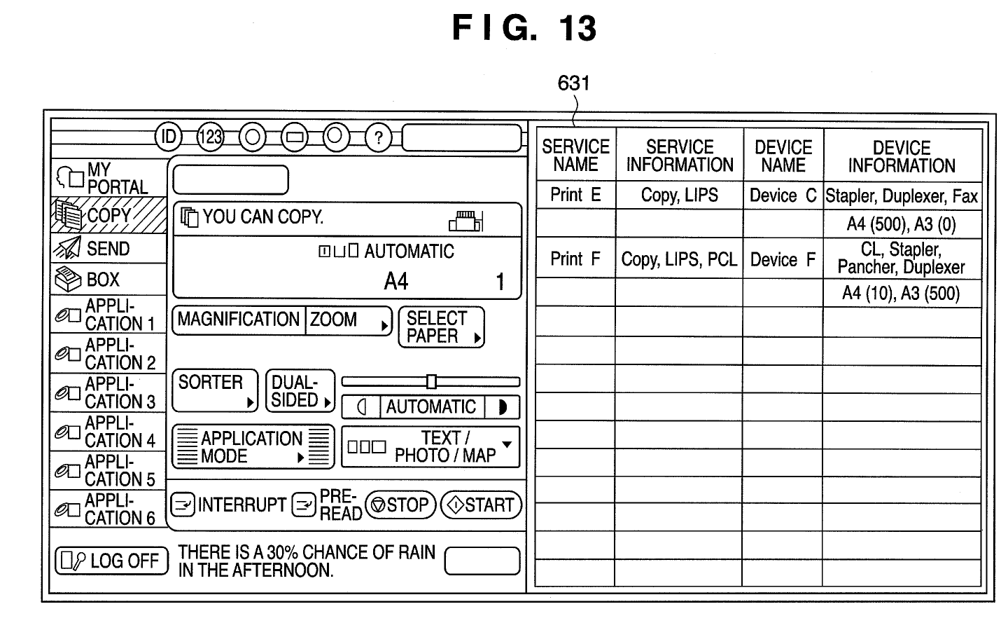

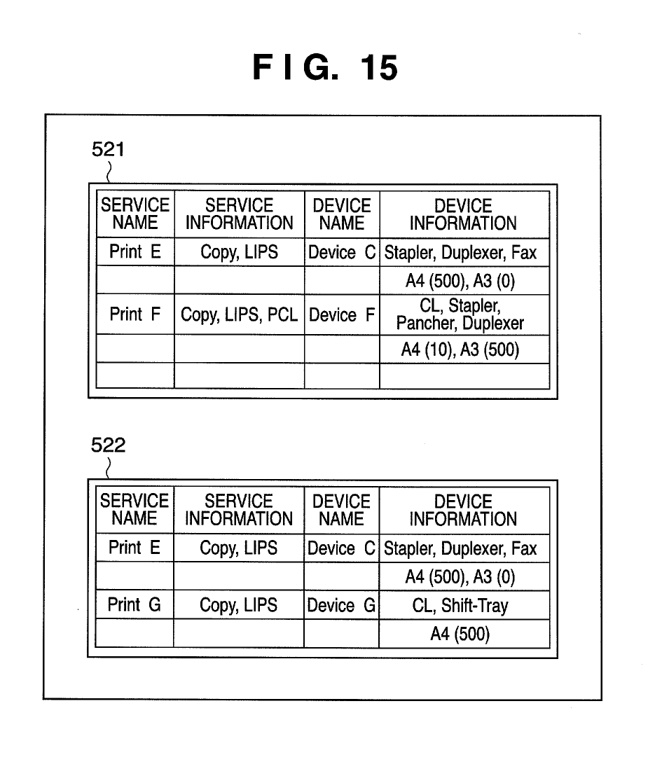

For example, in the service list 511 of FIG. 12, “Print G” does not allow the feeding of A3 paper and thus is removed from the list. In other words, only those services that can work in conjunction as print destinations, those being “Print E” and “Print F,” are left on the list. At this time, the original service list is saved in the memory in the controller 110, and after it has been copied, “Print G” is deleted and a new list is created. The service list 521 of FIG. 15 is an example of this list. The list 521 is then read out and displayed as a service list 631 on the operation portion 150 (FIG. 13).

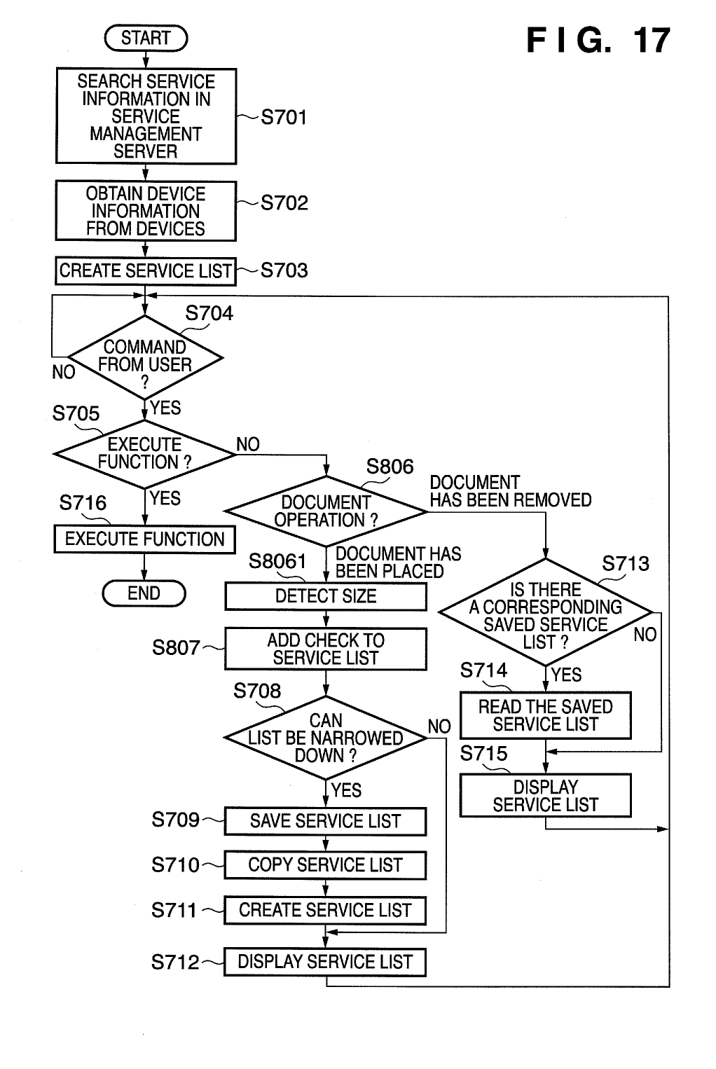

Next, the flowchart of FIG. 17 is used to describe the flow of the processing. In this flowchart, processes that are identical to those of FIG. 16 are assigned the same reference numerals as before and will not be described. In step S705, if it is determined that the command that has been received from the user is not for execution of a function, then the procedure is advanced to step S806. In S806, the original document operation, that is, whether an original document has been placed or removed, is determined. If it is detected that an original document has been placed, then the procedure advances to S8061, and detection of its size is performed by a sensor. For example, if the detected size of the original document is A3, then in S807 the service list 511 of FIG. 12 is checked.

In S708, it is determined whether services and devices that are not applicable as copy print destinations for an A3 size original document can be removed from the service list, that is, whether or not it is possible to narrow down the service list display. If yes, then in S709 the service list 511 is saved in the memory of the controller 110 and in S710 the service list is copied. Then, in S711, a service list from which the service “Print G,” which is a service that is not applicable as a copy print destination of an A3 size original document, has been removed is created. Thus, like the service list 521 of FIG. 15, a service list in which only those services that are applicable as print destinations, those being “Print E” and “Print F,” remain is created. Next, in 7812, a service list is displayed like in 631 of FIG. 13. If in S708 it was not the setting of a function, such as a change to the service list, then in S712 the service list is used as is. After the service list is displayed in FIG. 13, the procedure is returned to S704.

If it is determined in S806 that the original document has been removed, then in S713 it is determined whether or not there is a service list that has been saved in S709. If there is a corresponding service list, then the saved service list is read out in S714 and is displayed in S715. If there is no corresponding service list, then in S715 the list is displayed as is. As above, the procedure is then returned to S704, and enters a state of standby for a command from the user.

If the nature of the command in S704 is determined in S705 to be the execution of a function, such as the start of copying, then in S716 the function (copying) is executed and finished. It should be noted that if it is determined in S806 that the original document has been removed, then it is not possible to execute copying even if there has been a command for execution of this function, and thus here a display that urges the user to set the original document or to select image data from the HDD 160 is executed on the operation portion 150. Then, after the image data to be sent to the service providing device has been specified, the image data are transferred to the service providing device.

### Third Embodiment

An information processing system is described as a third embodiment of the invention. This embodiment uses a case in which the copy function is used as an example, and describes a method of detecting that the user has set an original document on the reader portion 200 and then reading the original document before specifying the service and narrowing down the number of services in accordance with the original document that has been read. The configuration, etc., of the system is the same as in the first embodiment, and thus identical structures and processes have been assigned the same reference numerals as before and will not be described.

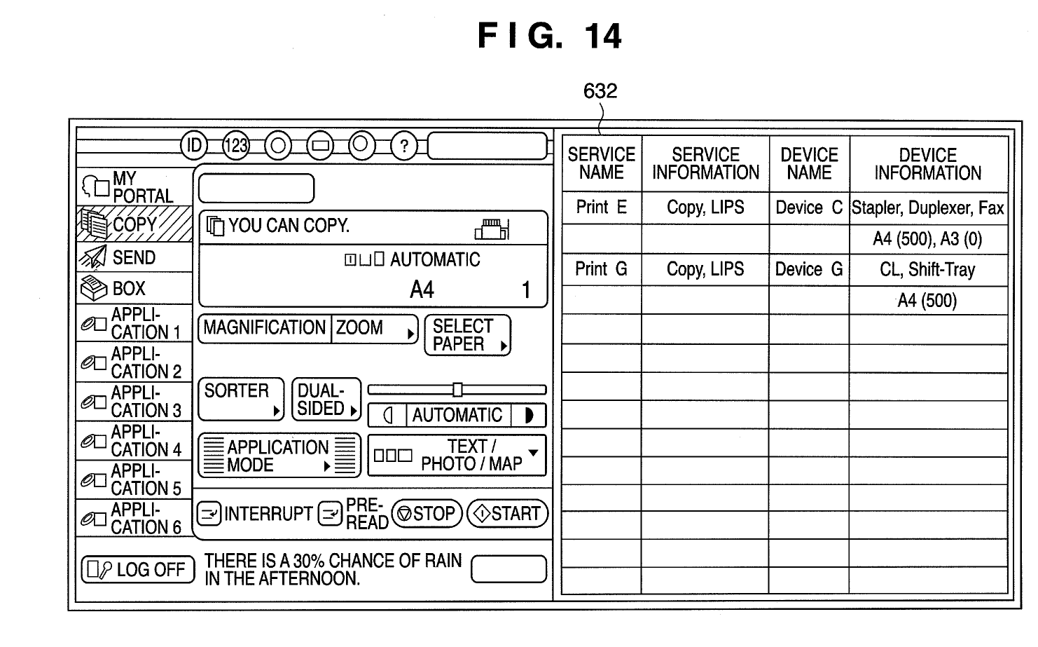

A state in which the copy key 604 in FIG. 8 has been pressed and FIG. 9 is displayed is assumed. The service list is the service list 511 of FIG. 12, and in particular, the service list display is the state of 626 in FIG. 9. Here, an original document has been set on the original document feeding unit 250, and when an original document pre-read command (a copy start key 641 is pressed in a state where an original document pre-read key 640 has been checked) is made, the original document is fed and its size is detected and the number of sheets of the original document is counted by the scanner unit 210. For example, it may be determined that there are 20 sheets of an A4 size document. Then, based on the result of this detection, services and devices that are not applicable as a print destination for copying 20 sheets of an A4 size original document are removed from the list. For example, in the service list 511 of FIG. 12, the service “Print F,” with which it is not possible to print a copy of 20 sheets of an A4 size original document, does not match and thus is removed from the list. In other words, only those services that are applicable as print destinations, those being “Print E” and “Print G,” are left on the list. At this time, the original service list is saved in the memory of the controller 110, and after it has been copied, a new list is created. The service list 522 of FIG. 15 is an example. This list is then read out, and the display on the operation portion 150 becomes that of FIG. 14 and the service list display becomes that of 632.

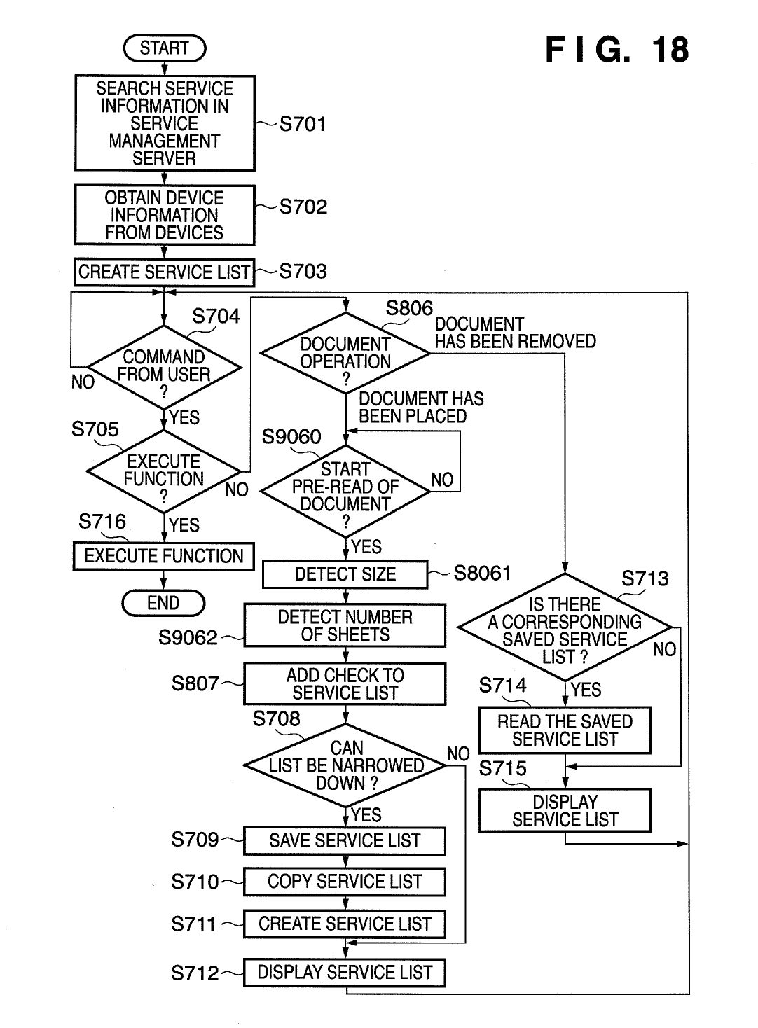

Next, the flowchart of FIG. 18 is used to describe the flow of the processing. In this flowchart, processes that are identical to those of FIG. 16 are assigned the same reference numerals as before and will not be described. In step S705, if it is determined that a command that has been received from the user is not for the execution of a function, then the procedure is advanced to step S806.

In S806, the original document operation, that is, whether an original document has been placed or removed, is determined. If it is detected that an original document has been placed, then the procedure advances to S9060, and whether or not the original document has been pre-read is detected. When the copy start key 641 is pressed in a state where the original document pre-read key 640 has been checked in FIG. 9, then the original document is fed and its size is detected and the number of sheets of the original document is counted. Then, as described above, if the results of this size detection are such that in S8061 it is detected that that the original document is A4 size and in S9062 it is detected that there are 20 sheets of original document, then in S707 a check is added to the service list 511 of FIG. 12. Then, in S708, it is determined whether or not it is possible to remove services and devices that are not applicable as print destinations for copying 20 sheets of an A4 size original document, that is, whether or not the service list display can be narrowed down. If yes, then in S709 the service list 511 is saved in the memory in the controller 110 and the service list is copied in S710. Then, in S711, the service “Print F,” which is not applicable as a print destination for copying an A4 size original document, is removed from the service list 511. By doing this, as shown by the service list 522 of FIG. 15, a service list in which only “Print E” and “Print G,” which are services that are applicable as print destinations, remain is created. Next, in S712, a service list 632 is displayed like in FIG. 14. If in S708 there was no setting of functions such as a change to the service list, then in S712 the service list is used as is. After the service list has been displayed as in FIG. 14, the procedure is returned to S704.

If it is determined in S806 that the original document has been removed, then in S713 it is determined whether or not there is a service list that has been saved in S709. If there is a corresponding service list, then the saved service list is read out in S714 and is displayed in S715. If there is no corresponding service list, then in S715 the list is displayed as is. Then, as above, the procedure is returned to S704, and enters a state of standby for a command from the user. If the nature of the command in S704 is determined in S705 to be the execution of a function, such as the start of copying, then in S716 the function (copying) is executed and finished.

It should be noted that in the above description, the condition was to narrow down the size and the number of sheets of the original document by pre-reading original document, but for example, it is also possible to add other conditions, such as whether or not the image is monochrome.

### Other Embodiments

Embodiments of the present invention were described in detail above, and although the first through third embodiments were each described independently, the functions recited in those embodiments are not exclusive from one another and they may be combined. For example, the determination of step S706 listed in FIG. 16 and the determination of step S806 listed in FIG. 17 can be performed simultaneously, and moreover, it is also possible to combine the processing of steps 9060 and S9062. The second embodiment was described with regard to an example in which the size of the original document that has been set on the reader portion 200 is detected, but the invention is not limited to this. For example, it is also possible to narrow down the service list based on what type of external device (digital camera, digital video camera, or portable telephone, for example) is connected to an interface such as a USB or the IEEE 1394. Alternatively, it is also possible to narrow down the service list that is received by each user in accordance with the password input by the user or his ID card, for instance. As regards the service, a example was described in which a copy service for printing image data that have been sent from a service use computer on a service providing device, but other services are applicable as well.

The invention is applicable for systems made of a plurality of machines as well for as a device that is made from a single machine.

It should be noted that the present invention can also be achieved by directly or remotely supplying a program for achieving the functions of the embodiments described above to a system or a device, and then having that system or device read out and execute the program code that has been supplied. Consequently, in order to achieve the functions of the invention on a computer, the program code that is installed on the computer itself also falls within the technical scope of the invention.

In this case, as long as the program has the program function, the form in which it takes does not matter, and it may be object code, a program that is executed by an interpreter, or script data that is supplied to an OS.

Examples of recording media for supplying the program include Floppy (registered trademark) disks, hard disks, optical disks, and optomagnetic disks. Other possibilities include MOs, CD-ROMs, CD-Rs, CD-RWs, magnetic tape, nonvolatile memory cards, ROMs, and DVDs (DVD-ROMs and DVD-Rs).

In addition, it is also possible to employ the method of connecting to an Internet website using the client PC browser and then downloading the program of the invention directly, or a file that further includes an automatic installation function, onto a recording medium such as a hard disk. It is also possible to divide up the program code making up the program according to the invention into a plurality of files and then to download each of the files from different homepages. In other words, a WWW site that allows a program for realizing the functions of the invention on a computer to be downloaded by a plural number of users also falls within the scope of the invention. It is also possible to encrypt the program according to the invention and store it on a storage medium such as a CD-ROM, and distribute this to users. It is also possible to allow users that have passed predetermined conditions to download key information that decodes the encryption from a homepage via the Internet, and then, by the user using that key information, to run the encrypted program and install it on a computer.

The OS, etc., that is running on the computer performs some or all of the actual processing based on a command from the program, and through this processing it is also possible to achieve the functions of the embodiments discussed above.

Further, a case in which the program according to the invention is written to a memory that is provided in a PC function expansion unit, and then, based on that program, the CPU, etc., provided in that function expansion unit carries out some or all of the actual processing, also falls within the scope of the invention.

It is possible to provide service search technology that is more user-friendly and that places less of a burden on the network.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-307224 filed on Nov. 13, 2006, which is hereby incorporated by reference herein in its entirety.

What is claimed is:

1. An information processing method comprising:
searching for services that exists on a network;
creating and saving a service list based on the searching result;
displaying the service list that has been saved;
inputting an operation which is related to one of services included in the displayed service list; and
changing the service list, in accordance with the input operation.

2. The information processing method according to claim 1,
wherein the service list is changed by deleting a service that does not agree with the service content indicated by the input operation, and by creating a saving a new service list.

3. The information processing method according to claim 2,
further comprising retaining the previous service list from which the service is deleted, even through a new service list is created and saved.

4. The information processing method according to claim 1,
wherein the input operation is an operation by a user to a user interface.

5. The information processing method according to claim 1,
wherein the input operation is an operation for setting an original document on a scanner.

6. The information processing method according to claim 5,
further comprising changing services that are included in the service list using the results of scanning the original document that has been set on the scanner.

7. An information processing system comprising:
a search unit configured to search for services on a network;
a creation unit configured to create and save a service list using the results obtained by the search unit;
a display unit configured to read out and display the service list that has been saved;
an input unit configured to allow a user to input an operation which is related to one of services included in the service list displayed by the display unit; and
a service list changing unit configured to change the service list, in accordance with the operation input by the input unit.

8. A computer-readable storage medium storing a computer program that causes a computer to execute, the computer program comprising:
a code to search for services that exists on a network;
a code to create and to save a service list based on the searching result;
a code to display the service list that has been saved;
a code to input an operation which is related to one of services included in the displayed service list; and
a code to change the service list, in accordance with the input operation.
